(19) United States
(12) Patent Application Publication
(10) Pub. No.: US 2005/0283294 A1
(43) Pub. Date: Dec. 22, 2005

(54) Method and apparatus for machine guidance at a work site

(76) Inventors: Allen A. Lehman JR., Payson, AZ (US); James Knapp, Casa Grande, AZ (US); Evan V. Hansen, Calgary (CA)

Correspondence Address: WEISS & MOY PC, 4204 NORTH BROWN AVENUE, SCOTTSDALE, AZ, 85251, US

(21) Appl. No.: 10/868,983

(22) Filed: Jun. 16, 2004

(51) Int. Cl. G06F 19/00

(52) U.S. Cl. 701/50; 701/23

(57) ABSTRACT

A method and apparatus for providing machine guidance of all types of earthmoving machinery, other heavy equipment, and work site vehicles. The method and apparatus is applicable to any industrial work site such as a construction site, open pit mine, quarry operation, or landfill. The machinery, equipment, or vehicle is not required to be equipped with a positional receiver of any kind. The position of all machinery, equipment, and vehicles is performed by employing an array of 3D laser scanners (or any 3D digital imaging devices) positioned throughout the work site. 3D images of the work site are transmitted from the laser scanners to a remote processing unit via a data link or network. The processing unit analyzes the images and determines the position of the machinery, equipment and vehicles. The positions are transmitted to the machinery, equipment, and vehicles via the data link or network. The current Digital Terrain Model (DTM) of the work site is captured and stored in real time in the form of a 3-D digital image, as a by-product of scanning the work site and determining the position of the work site machinery, equipment, and vehicles. The remote processing unit compares the current DTM to the work site's design DTM and transmits the difference to the required machinery, equipment, and vehicles for feedback to their operators in real time.

### BACKGROUND OF THE INVENTION

1. Field of the Invention

This invention relates to industrial material moving and, more specifically, to an apparatus and methodology for the guidance, tracking and control of mobile machinery, and related material in an industrial material moving environment. These industrial environments may include mine sites, construction sites, quarries, and any other sites where mobile machinery and material handling are active. Mobile machinery may include any machinery utilized in the process of moving, producing or disposing of material.

2. Description of the Prior Art

Current machine guidance systems have increased machine productivity a considerable amount. However, existing systems require expensive machine intensive hardware and positioning components, and the requirement to occupy a surface prior to understanding its relative position to a design surface. Current methodologies only allow a machine to gather current surface information by physically traveling over the surface and recording the machines position as it progresses. This information is then compared to a design surface to guide the machines material handling function. This method requires the machine to operate blind for the first pass of each piece of virgin ground. Accurate material placement cannot be calculated until the machine has completed a first pass of the entire material surface to be worked. Once a machine has made of first pass of an area, a digital terrain model (DTM) can then be generated to compare to the design model. This process of the machine creating the DTM based upon its movement over a surface hinders the ultimate productivity of handling the material correctly from the first pass.

Existing machine guidance technology stores, compares, and computes the machines relative position-to a design surface on-board the machine on individual processors. This approach does not allow for multiple machines working on a site to update one another's existing surface. Without the ability to work from the same active surface, multiple machines cannot work together on a single active surface in the same work area. This severely limits the capability of the technology to provide ultimate machine productivity.

The majority of existing machine positioning technologies, require broad visibility to the sky to provide an accurate machine position. This has been a significant obstacle in the application of the technology to target users such as pit mining operations, quarry operations and construction sites where obstructions of the horizon limit the availability of the enabling technology. Underground operations are completely excluded from the benefits of the technology, as they have no view of the sky to make the current technology operate. In places where a view of the horizon is unavailable, the operators must revert back to operating by feel and experience. Unfortunately, as operators have become reliant on the new guidance technologies, their feel and experience is impaired when it comes to operating when the system is disabled.

Therefore, there is a need for improved machine guidance technologies. The improved machine guidance technologies will correct deficiencies in coverage, machine knowledge of location and accuracies of work site surfaces amongst multiple machines. The apparatus and methodology employed will allow multiple machines to work from the same active surface as the data processing is conducted at a remote processing unit and all machines are then updated with the same progressive surface information. Additionally, the methodology does not require any machines to travel the surface as a means of determining existing surface topography. All existing surface topography and machine positioning is determined via remote 3D digital imaging devices.

### SUMMARY OF THE INVENTION

In accordance with one embodiment of the present invention, it is an object of the present invention to provide improved machine guidance technologies

It is another object of the present invention to provide improved machine guidance technologies that will correct deficiencies in coverage, machine knowledge of location and accuracies of work site surfaces amongst multiple machines.

It is another object of the present invention to provide an apparatus and methodology that will allow multiple machines to work from the same active surface as the data processing is conducted at a remote processing unit and all machines are then updated with the same progressive surface information.

It is still another object of the present invention to provide a methodology that does not require any machines to travel the surface as a means of determining existing surface topography. All existing surface topography and machine positioning is determined via remote 3D digital imaging devices.

### BRIEF DESCRIPTION OF THE EMBODIMENTS

In accordance with one embodiment of the present invention a system for providing work site guidance for machines and vehicles at the work site is disclosed. The system has at least one imaging device. The imaging device is used for taking three dimensional images of different sections of the entire work site including all machines, vehicles, and potential obstacles. A remote processing unit is coupled to the at least one imaging device. The remote processing unit is used for collecting the three dimensional images and creating a single three dimensional image of the entire work site. A first memory device is coupled to the remote processing unit for storing the three dimensional images of different sections of the work site. A second memory device is coupled to the remote processing unit for storing a design file of the work site. The remote processing unit comparing the single three dimensional image of the entire work site to the design file, the differences between the single three dimensional image of the entire work site and the design file being sent to the machines and vehicles.

In accordance with another embodiment of the present invention, a method for providing work site machine guidance is disclosed. The method comprising: producing 3-D digital images of each section of the work site; transmitting the 3-D digital images to a remote processing unit for storage; combining the 3-D digital images into a database containing the current DTM of the work site; identifying machinery, equipment, and vehicles within the 3-D digital images; calculating the difference between the current DTM and a work site design DTM; transmitting a 3-D position of the machinery, equipment, or vehicles to the machinery, equipment, and vehicles themselves; transmitting the difference between the current DTM and the work site design DTM to the machinery, equipment, and vehicles themselves; and using the difference between the 3D position of the machinery, equipment, or vehicles in the current DTM and the work site design DTM to provide automatic positioning control of the machinery, equipment, and vehicles.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a schematic representation of a worksite employing an embodiment of the present invention.

FIG. 2 is a schematic representation of the method for collecting 3D digital images and forming the current DTM, to carry out the present invention.

FIG. 3 is a schematic representation of the method for processing the current DTM comprising of 3D digital images, and determining the 3D position of the machinery, equipment, and vehicles in the local coordinate system and also the difference between the current DTM and the design DTM, to carry out the present invention.

FIG. 4 is a schematic representation of the method for receiving the 3D position of the machinery, equipment, and vehicles in the local coordinate system and also the difference between the current DTM and the design DTM, and displaying it to the operator to carry out the present invention.

FIG. 5 is a schematic representation of machinery, equipment, or vehicle employing an embodiment of the present invention.

### DETAILED DESCRIPTION OF THE PREFERRED EMBODIMENT

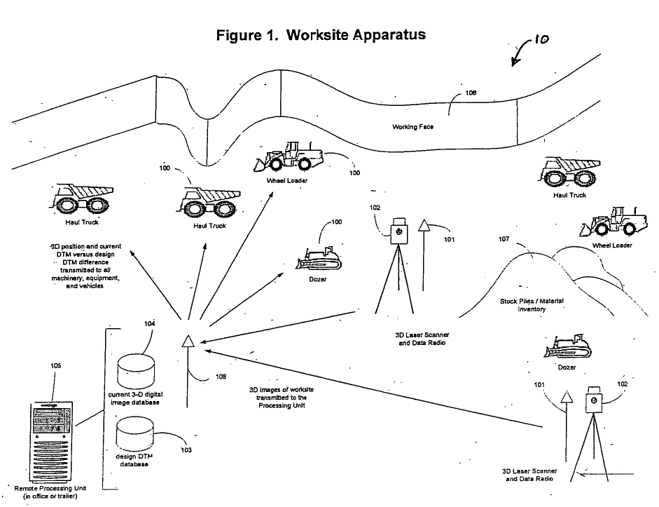

Referring to FIG. 1, an example deployment of the apparatus 10 at a worksite is shown. 3-D digital imaging devices 102 are placed throughout the work site. The 3-D digital imaging devices may be 3-D laser scanners, radar, photogrametry, or the like. The listing of the above should not be seen as to limit the scope of the present invention. The number of 3-D digital imaging devices 102 are such that an image of the entire worksite (including all machinery, equipment, vehicles 100, materials, stockpiles 107, and working faces 106) can be composed from the images from the individual devices. The 3-D digital imaging devices 102 are placed over a known position in the worksite's 3-D coordinate system, allowing all 3-D images to be directly tied to the worksite's coordinate system. The 3-D digital images from each device 102 are transmitted via the data link 101. The data link 101 may consist of a wireless radio network, a wired network such as traditional Ethernet, a fibre optic link, or any combination of the above. The listing of the above should not be seen as to limit the scope of the present invention.

The 3-D digital images are collected at the remote processing unit 105, typically located at the worksite office or in a portable trailer, via the data link at 108. The individual 3-D digital images from the individual 3-D digital imaging devices 102 are combined to create one 3-D digital image of the worksite. In the case of a worksite that includes earthmoving equipment, the 3-D digital image may also be referred to as a Digital Terrain Model (DTM). The individual 3-D digital images are stored in the current 3-D digital image database 104.

The 3-D digital images in the current 3-D digital image database 104 are scanned by the remote processing unit 105. The machinery, equipment, and vehicles 100 of interest are identified in the image using a vehicle identification algorithm which is described below. The 3-D position of the machinery, equipment, and vehicles 100 are determined by referencing their position within the images which are in turn referenced to the 3-D coordinate system of the worksite. The 3-D position of the machinery, equipment, and vehicles 100 is transmitted to the operator of the machinery, equipment and vehicles via the data link 108. Additionally, the remote processing unit 105 can determine the 3-D position of the machinery, equipment, and vehicles 100 with respect to the design DTM for the worksite. The design model consists of design files or design DTMs contained in the design DTM database 103. The 3-D differences between the current DTM and the intended design DTM are transmitted via the data link 108. The 3-D differences can be transmitted to the machinery, equipment, or vehicle 100 prior to the machinery, equipment, or vehicle moving onto the surface.

The 3-D digital image database 104 includes features such as the working face 106 and material stock piles 107. In addition to using the 3-D digital images of the features for the guidance of the machinery, equipment, and vehicles the 3-D digital images can also be used for tracking material handling and calculating volumetrics.

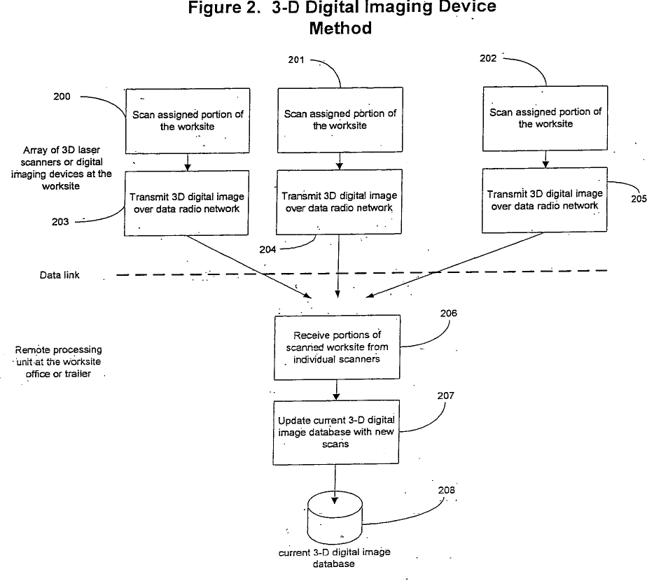

Referring now to FIG. 2, the method for utilizing the 3-D digital imaging devices is given in a block diagram. The array of 3-D digital imaging devices shown as blocks 200, 201, and 202 each scan a portion of the worksite that has been assigned to them or is visible to them. The 3-D digital imaging devices transmit their individual 3-D digital images per block 205 over the data link. The individual 3-D digital images are received at 206 at the remote processing unit. At block 207 the images are used to update the current 3-D digital image database 208, creating a 3-D digital image of the entire worksite that can be used as a current DTM.

Referring now to FIG. 3, the method used by the remote processing unit is given in a block diagram. The images in the current 3-D digital image database 300 are scanned in near real-time. The machinery, equipment, and vehicle identification algorithm 301 is used to locate and identify the machinery, equipment, and vehicles in the images. At block 302, once the machinery, equipment, and vehicles have been identified, their 3-D position in the worksite coordinate system is determined by referencing their position in the 3-D image that in turn is referenced to the 3-D coordinate system. At block 305 the 3-D position in the worksite coordinate system of the machinery, equipment, and vehicles is transmitted over the data link to the machinery, equipment, and vehicles.

Additionally, at block 304 the design DTM database 303 is referenced. The current DTM determined from the 3-D digital image database 300 is compared to the design DTM at the location of the machinery, equipment, and vehicles. The difference between the current DTM and the design DTM is transmitted at block 305 to the operators of the machinery, equipment, and vehicles.

The 3-D position in the worksite coordinate system of the machinery, equipment, or vehicles along with the differences between the current DTM and the design DTM are transmitted over the data link and received on the individual pieces of machinery, equipment, and the vehicles at blocks 306, 307, and 308. The information is displayed to the operator and or used for automatic machine, equipment, or vehicle control.

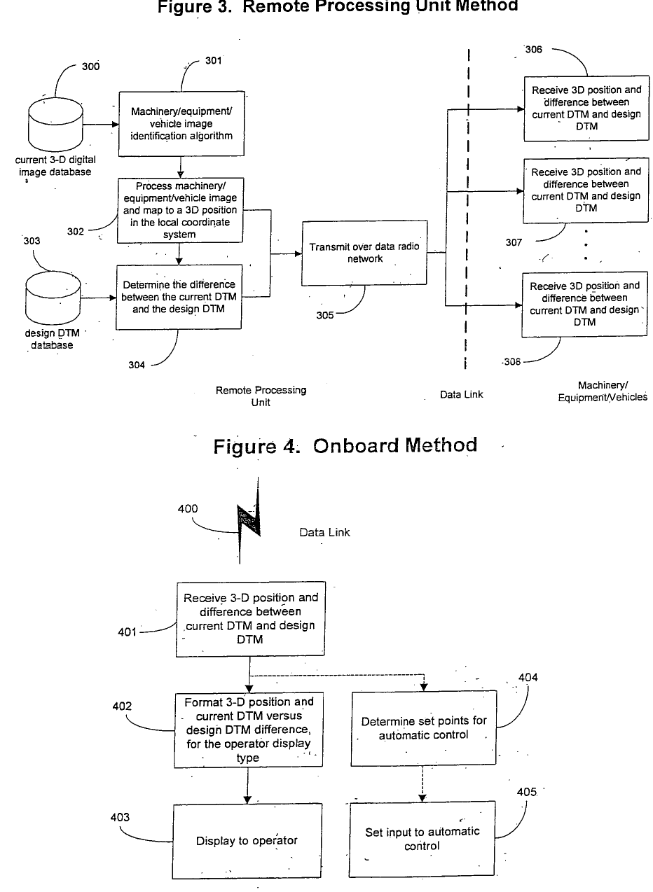

Referring now to FIG. 4, the method for receiving and utilizing the information from the data link onboard the machinery, equipment, and vehicles is given in a block diagram. The 3-D position in the worksite coordinate system of each piece of machinery, equipment, or each vehicle and the difference between the current DTM and the design DTM are received at block 401 from the data link 400. At block 402 the 3-D position and difference between the current DTM and the design DTM are formatted for the type of display that has been installed onboard. The information is then displayed to the operator at block 403 for the operator's empowerment.

Additionally, the 3-D position of the piece of machinery, equipment, or vehicle along with the difference between the current DTM and the design DTM may be used to determine the set points for automatic control of the machinery, equipment, or vehicle at block 404. At block 405 the set points are made on the automatic control module. The automatic control module is of the electro-hydraulic type offered after market by many OEMs for heavy equipment.

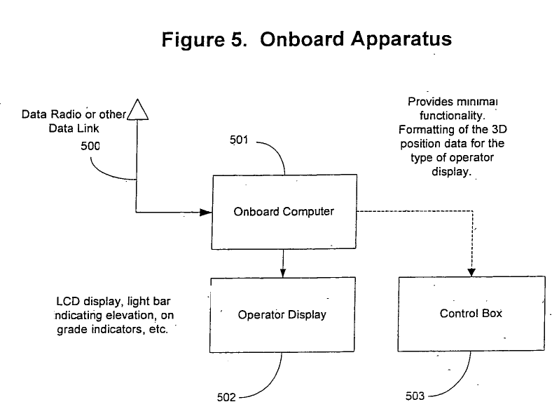

Referring now to FIG. 5, a schematic representation of the onboard apparatus used in the vehicles 100 is provided. The 3-D position in the worksite coordinate system for the appropriate piece of machinery, equipment, or vehicle 100 is received on the data link 500 along with the difference between the current DTM and the design DTM. The onboard computer 501 formats the information for the type of operator display 502. Additionally, the onboard computer 501 may determine the appropriate set points for the automatic control box 503 based on the 3-D position of the piece of machinery, equipment, or vehicle and also on the difference between the current DTM and the design DTM. The automatic control box 503 is of the electro-hydraulic type offered after market by many OEMs for installation on heavy equipment.

The onboard computer 501 is not required to be a high performance unit. Minimal computation is done onboard the piece of machinery, equipment, or the vehicle 100. The majority of the processing is done at the remote processing unit. Detailed knowledge of the current DTM or the design DTM is not required onboard. The control box 503 is optional.

### Operation

Referring to FIG. 1, the 3-D digital imaging devices 102 can be deployed following two strategies. In the first strategy, the 3-D digital imaging devices 102 can be placed so that their visibility of the worksite is maximized. The digital imaging devices are scanning or imaging the maximum possible area, hence reducing the number of devices that are required to be deployed. This reduces costs but has the disadvantage of being slower. In the second strategy, the speed of the overall invention can be increased if required, by deploying additional 3-D digital imaging devices. Each of the devices can be configured to scan or image a smaller area. Additional devices can be added until the desired image acquisition speed is achieved. Both strategies can also be optimized by configuring the 3-D digital imaging devices to scan or image the area of interest around the individual pieces of machinery, equipment, and vehicles at a faster rate than then remaining area of the worksite.

An added benefit of deploying the technology required by the invention is that a 3-D digital image or model-of the entire worksite is maintained in near real-time. Included in the model are worksite features such as the working face 106 and material stockpiles 107. This allows for the tracking of material at the worksite, performing volumetrics, and many other calculations that traditionally require deploying surveyors. A truly 3-D digital worksite is maintained in addition to the machine guidance that is performed.

A data link 108 is required to transmit the 3-D position in worksite coordinates and also to transmit the difference between the current DTM and the design DTM to the individual pieces of machinery, equipment, and to the vehicles. For mobile machinery and equipment, and for vehicles, the data link 108 is a wireless data radio network. The bandwidth required to transmit the information is minimal. A data link 101 is also required to obtain the 3-D digital images from the array of 3-D digital imaging devices 102. This data link 101 can be a combination of wireless data radio networks, a wired traditional Ethernet like networks, or fibre optic links. The 3-D digital imaging devices are maintained at a fixed location at the worksite, so a wireless data link 101 is not necessarily required. The bandwidth requirement of the data link 101 will vary from worksite to worksite and will be defined by the size of the worksite being scanned or imaged, the number and type of digital imaging devices deployed, and the size of the area each device is scanning or imaging.

The current 3-D digital image database 104 contains all of the images acquired from the array of 3-D digital imaging devices 102, in near real-time. The images in the 3-D digital image database 104 combine to provide a current 3-D digital image of the entire worksite. From the 3-D digital image of the worksite, the images of all of the machinery, equipment, and vehicles of interest can be detected and their positions extracted. The remaining portions of the 3-D digital image of the worksite is in effect a current DTM of the worksite. This results in an up to date current DTM always residing on the remote processing unit 105 in near real-time. The current DTM is always available in near real-time to all machinery, equipment, and vehicles. This is in contrast to traditional technologies where the current DTM is distributed across all of the equipment at the work site.

Referring now to FIG. 3, block 301, the algorithm for identifying the machinery, equipment, and vehicles in the 3-D digital images is performed by identifying known features of known geometry for each piece of -machinery, equipment, and vehicle against the image. This allows the position of the machinery, equipment, and vehicles to be determined within the 3-D digital image at block 302. The 3-D position of the machinery, equipment, and vehicles in work site coordinates in then known, as each image is referenced to the work site coordinates through the 3-D digital imaging device which is positioned over a known location. Alternatively, if the 3-D digital imaging device is not positioned over a known location, the 3-D digital image can be referenced to the work site coordinates by identifying other objects of a known location in the said image.

While the invention has been particularly shown and described with reference to preferred embodiments thereof, it will be understood by those skilled in the art that the foregoing and other changes in form and details may be made therein without departing from the spirit and scope of the invention.

1. A system for providing work site guidance for machines and vehicles at the work site comprising:
at least one imaging device for taking three dimensional images of different sections of the entire work site including all machines, vehicles, and potential obstacles;
a remote processing unit coupled to the at least one imaging device for collecting the three dimensional images and creating a single three dimensional image of the entire work site;
a first memory device coupled to the remote processing unit for storing the three dimensional images of different sections of the work site; and
a second memory device coupled to the remote processing unit for storing a design file of the work site, the remote processing unit comparing the single three dimensional image of the entire work site to the design file, the differences between the single three dimensional image of the entire work site and the design file being sent to the machines and vehicles.

2. A system for providing work site guidance for machines at the work site in accordance with claim 1 further comprising data links coupled to the at least one imaging device and to the remote processing unit for transmitting the three dimensional images of different sections of the work site to the remote processing unit and the differences between the single three dimensional image of the entire work site and the design file to the machines and vehicles.

3. A system for providing work site guidance for machines at the work site in accordance with claim 2 wherein the data links transmit the three dimensional images of different sections of the work site to the remote processing unit wirelessly.

4. A system for providing work site guidance for machines at the work site in accordance with claim 2 wherein the remote processing unit identifies the machines, vehicles, and potential obstacles and determines a 3-D position of each machine, vehicle, and obstacle in a local coordinate system.

5. A system for providing work site guidance for machines at the work site in accordance with claim 4 wherein the 3-D position of each machine, vehicle, and obstacle in a local coordinate system is transmitted to each machine and vehicle.

6. A system for providing work site guidance for machines at the work site in accordance with claim 4 wherein the remote processing unit calculates a difference between the 3-D position of each machine, vehicle, and obstacle and the design file, the difference being transmitted to the machines vehicles.

7. A system for providing work site guidance for machines at the work site in accordance with claim 4 further comprising automatic positioning control devices coupled to the machines and vehicles, the remote processing unit transmitting the difference between the 3-D position of each machine, vehicle, and obstacle and the design file to the automatic positioning control devices to control the machines and vehicles.

8. A system for providing work site guidance for machines at the work site in accordance with claim 1 further comprising means for controlling sections of the work site targeted by the at least one imaging device.

9. A method for providing work site machine guidance comprising:
producing 3-D digital images of each section of the work site;
transmitting the 3-D digital images to a remote processing unit for storage;
combining the 3-D digital images into a database containing the current DTM of the work site;
identifying machinery, equipment, and vehicles within the 3-D digital images;
calculating the difference between the current DTM and a work site design DTM;
transmitting a 3-D position of the machinery, equipment, or vehicles to the machinery, equipment, and vehicles themselves;
transmitting the difference between the current DTM and the work site design DTM to the machinery, equipment, and vehicles themselves; and
using the difference between the 3D position of the machinery, equipment, or vehicles in the current DTM and the work site design DTM to provide automatic positioning control of the machinery, equipment, and vehicles.

10. The method of claim 9 further comprising determining a portion of the work site for each 3-D digital imaging device to target.

11. The method of claim 9 further comprising receiving the 3-D position of the machinery, equipment, and vehicles on the machinery, equipment, or vehicles themselves and displaying it to an operator.

12. The method of claim 9 further comprising receiving the difference between the current DTM and the work site design DTM on the machinery, equipment, and vehicles themselves and displaying it to an operator.

13. The method of claim 9, wherein the step for identifying machinery, equipment, and vehicles within the 3D digital images further comprises:
determining an initial position of machinery, equipment, and vehicles;
determining an attitude of the machinery, equipment, and vehicles through identification of key physical features of the machinery, equipment, and vehicles in the 3D digital images and determining the orientation of the key physical features.

14. The method of claim 13 wherein determining an initial position of machinery, equipment, and vehicles further comprises determining an initial position of machinery, equipment, and vehicles through manual user identification of the approximate location in the 3D digital images

15. The method of claim 13 wherein determining an initial position of machinery, equipment, and vehicles further comprises determining an initial position of machinery, equipment, and vehicles through automated identification of key physical features of the machinery, equipment, and vehicles in the 3D digital images.

16. A system for providing work site guidance for machines and vehicles at the work site comprising:
at least one imaging device for taking three dimensional images of different sections of the entire work site including all machines, vehicles, and potential obstacles;
a remote processing unit coupled to the at least one imaging device for collecting the three dimensional images and creating a single three dimensional image of the entire work site, the remote processing unit identifies the machines, vehicles, and potential obstacles and determines a 3-D position of each machine, vehicle, and obstacle in a local coordinate system;
a first memory device coupled to the remote processing unit for storing the three dimensional images of different sections of the work site;
a second memory device coupled to the remote processing unit for storing a design file of the work site, the remote processing unit comparing the single three dimensional image of the entire work site to the design file, the differences between the single three dimensional image of the entire work site and the design file being sent to the machines and vehicles;
data links coupled to the at least one imaging device and to the remote processing unit for transmitting wirelessly the three dimensional images of different sections of the work site to the remote processing unit and the differences between the single three dimensional image of the entire work site and the design file to the machines and vehicles.

17. A system for providing work site guidance for machines at the work site in accordance with claim 16 wherein the 3-D position of each machine, vehicle, and obstacle in a local coordinate system is transmitted to each machine and vehicle.

18. A system for providing work site guidance for machines at the work site in accordance with claim 16 wherein the remote processing unit calculates a difference between the 3-D position of each machine, vehicle, and obstacle and the design file, the difference being transmitted to the machines vehicles.

19. A system for providing work site guidance for machines at the work site in accordance with claim 16 further comprising automatic positioning control devices coupled to the machines and vehicles, the remote processing unit transmitting the difference between the 3-D position of each machine, vehicle, and obstacle and the design file to the automatic positioning control devices to control the machines and vehicles.

20. A system for providing work site guidance for machines at the work site in accordance with claim 16 further comprising means for controlling sections of the work site targeted by the at least one imaging device.
